(19) United States
(12) Patent Application Publication
(10) Pub. No.: US 2006/0179962 A1
(43) Pub. Date: Aug. 17, 2006

(54) Methods and systems for robust transmission mode selection and control

(76) Inventors: Kerfegar K. Katrak, Fenton, MI (US); Paul A. Bauerle, Fenton, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/059,906

(22) Filed: Feb. 17, 2005

(51) Int. Cl. F16H 61/00

(52) U.S. Cl. 74/335

(57) ABSTRACT

Systems, methods and devices are provided for placing a transmission into a desired operating state in response to a multi-position actuator manipulated by a vehicle operator. Several switch contacts, including at least one ternary switching contact, provide input signals representative of the position of the actuator. Control logic then determines the desired state for the transmission based upon the input signals received. The desired transmission operating state is determined from any number of operating states defined by ternary and/or discrete values of the input signals, and can. be electronically selected and/or indicated to the vehicle operator.

### TECHNICAL FIELD

The present invention generally relates to transmission control logic, and more particularly relates to methods, systems and devices for providing multi-state switching and control for a vehicle transmission.

### BACKGROUND

Transmissions found on most automobiles and other vehicles allow a relatively narrow range of engine speeds to produce a wider range of vehicle operating speeds. Transmissions typically include several gears that adjust the relative speed of rotation between the engine drive shaft and the live axel that drives the wheels or otherwise propels the vehicle. By manually or automatically selecting the appropriate transmission gear, the vehicle operator can effectively control the torque produced by the engine while keeping the engine operating at an appropriate speed.

Many modern automatic transmissions are electronically controlled by an electronic transmission range selector (ETRS) or other controlling module on board the vehicle. Electronic controllers typically shift gears or otherwise adjust the operation of the transmission by providing electrical signals to solenoids or other devices that actuate clutches or bands within the transmission. Many transmission controls provide sophisticated engine and torque control based upon such factors as vehicle speed, engine speed, braking status, throttle position and/or the like, as well as mode selection or other input received from the vehicle operator.

Although electronic transmission control can significantly improve vehicle performance and safety, such controls are generally limited by the amount of data that can be provided on a finite number of processor inputs. In particular, the number of processor inputs typically reserved for switch inputs from a transmission mode selector can be significant. Conventional transmission mode selectors implemented with discrete components, for example, typically use four or more signal inputs to represent standard transmission modes such as “Park”, “Neutral”, “Drive” and “Reverse”. Each of these signal inputs typically require a dedicated pin or other input on a control module, with additional transmission modes requiring additional inputs to the control circuitry. Further, because many different types of vehicles can have widely varying transmissions and electronic control resources, difficulties arise in generating a signaling scheme that can be readily adopted in many different types of vehicles and vehicle control environments.

It is therefore desirable to formulate a transmission control that is capable of efficiently representing all of the operating states of the transmission without sacrificing safety or robustness. Moreover, it is desirable to create a flexible architecture for transmission control that is readily modifiable and adoptable across a wide variety of vehicles and environments. Furthermore, other desirable features and characteristics will become apparent from the subsequent detailed description and the appended claims, taken in conjunction with the accompanying drawings and the foregoing technical field and background.

### BRIEF SUMMARY

According to various exemplary embodiments, systems, methods and devices are provided for placing a transmission into a desired operating state in response to a position of a multi-position actuator manipulated by a vehicle operator. Several switch contacts, including at least one ternary switching contact, provide input signals representative of the position of the actuator. Control logic then determines the desired state for the transmission based upon the input signals received. The desired operating state is suitably determined from any number of operating states defined by the input values. This state may then be electronically selected at the transmission and/or indicated to the vehicle operator as appropriate. In various embodiments, ternary switching is used in combination with binary switching to efficiently implement multi-state controls capable of selecting and/or identifying the various states of the vehicle transmission. Moreover, the techniques described herein may be implemented in a modular architecture wherein various ternary and/or discrete signal inputs from the mode selector are provided to one or more control modules.

### BRIEF DESCRIPTION OF THE DRAWINGS

The present invention will hereinafter be described in conjunction with the following drawing figures, wherein like numerals denote like elements, and:

FIG. 1 is a block diagram of an exemplary vehicle;

FIG. 2 is a circuit diagram of an exemplary embodiment of a switching circuit;

FIG. 3 is a circuit diagram of an alternate exemplary embodiment of a switching circuit;

FIG. 4 is a diagram of an exemplary switching system for processing input signals from multiple switches;

FIG. 5 is a block diagram showing an exemplary architecture for processing switching signals in a transmission control system;

FIG. 6 is a block diagram showing an exemplary transmission control system that can be implemented with three ternary and two discrete signal inputs;

FIG. 7 is a diagram of an exemplary switch contact layout scheme for implementing the exemplary ternary switching shown in FIG. 6; and

FIG. 8 is a diagram of an exemplary layout scheme for a transmission control system implemented with four ternary inputs.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

According to various exemplary embodiments, a transmission control and/or indicator system exploits ternary signaling techniques to provide a flexible yet robust architecture. Various embodiments can be implemented with two or more ternary switch contacts either alone or in combination with one or more binary switches. By using ternary switching, the number of switches required to represent the various states of the transmission can be reduced in comparison to similar binary implementations, and/or the robustness of the control system can be improved.

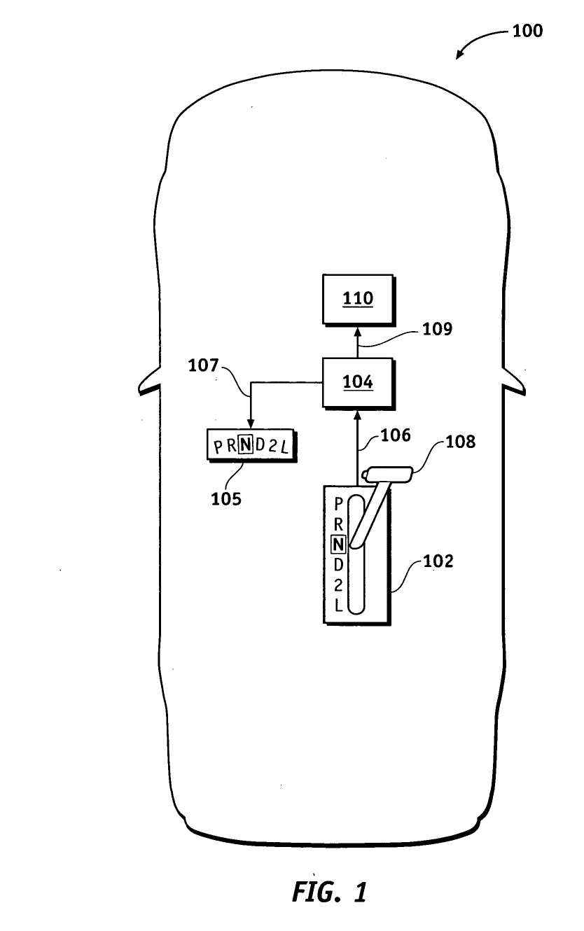

Turning now to the drawing figures and with initial reference to FIG. 1, an exemplary vehicle 100 suitably includes a control module 104 capable of providing a command signal 109 to a transmission 110. Control module 104 suitably receives one or more control signals 106 from a transmission mode selector 102 to indicate the position of an actuator 108 or other position selector as appropriate. Mode selector 102 is any mechanical, electronic or other device capable of receiving an input from a vehicle operator to

Control module 104 may also provide one or more indication signals 107 to optional indicator 105, which can be implemented with any digital or analog indicator capable of representing the status of position selector 102 and/or transmission 110. In various embodiments, indicator 105 is a conventional dashboard indicator.

Control module 104 may be implemented with any engine control module (ECM), electronic transmission range selector (ETRS), microcontroller, digital processor and/or other circuitry capable of receiving input data 106 and providing appropriate output signals 107 and/or 109. In various further embodiments, some or all of signals 106 can be sent to different control modules to improve flexibility and adoptability. If input pins are limited on a vehicle ETRS, for example, some or all of the signals 106 may be alternately provided to an ECM or other processing component on vehicle 100, with state or control data interchanged between the various processing modules as appropriate. Examples of such concepts are described more fully below.

Selector 102 is any device capable of providing various logic signals 106 to a controller or other component 104 in response to user commands, sensor readings or other input stimuli. In an exemplary embodiment, selector 102 responds to displacement or activation of a lever 108 or other actuator as appropriate. Various selectors 102 may be formulated with electrical, electronic and/or mechanical actuators to produce appropriate binary and/or ternary signals onto one or more wires or other electrical conductors, as described more fully below. These signals may be processed by controller 104 to place transmission 110 into desired states as appropriate. In various embodiments, any number of binary and/or ternary signals 106 may be provided between selector 102 and controller 104, with logic in controller 104 (or another processing device) combining or otherwise processing the various signals 106 to extract meaningful information about the location of actuator 108, which corresponds to a desired operating state of transmission 110.

Many types of actuator or stick-based control devices provide several output signals 106 that can be processed to determine the state of a single actuator 108. Lever 108 may correspond to the actuator in a conventional automatic transmission mode selector or other device operating within one or more degrees of freedom. In alternate embodiments, lever 108 moves in a ball-and-socket or other arrangement that allows multiple directions of movement. The concepts described herein may be readily adapted to operate with any type of mechanical selector 102, including any type of lever, stick, or other actuator that moves with respect to the vehicle via any slidable, rotatable or other coupling (e.g. hinge, slider, ball-and-socket, universal joint, etc.).

As briefly mentioned above, ternary switching concepts may provide significant benefits over conventional binary switches in many applications. Ternary switches, for example, may be used to reduce the number of switches used to represent various states, and/or may be used to increase the robustness of the overall switching system. Because ternary switches are capable of representing more data than binary switches on a single electrical conductor, ternary signaling schemes can result in more information being transmitted on a given number of conductors, and/or may provide equivalent data using fewer conductors than equivalent binary implementations.

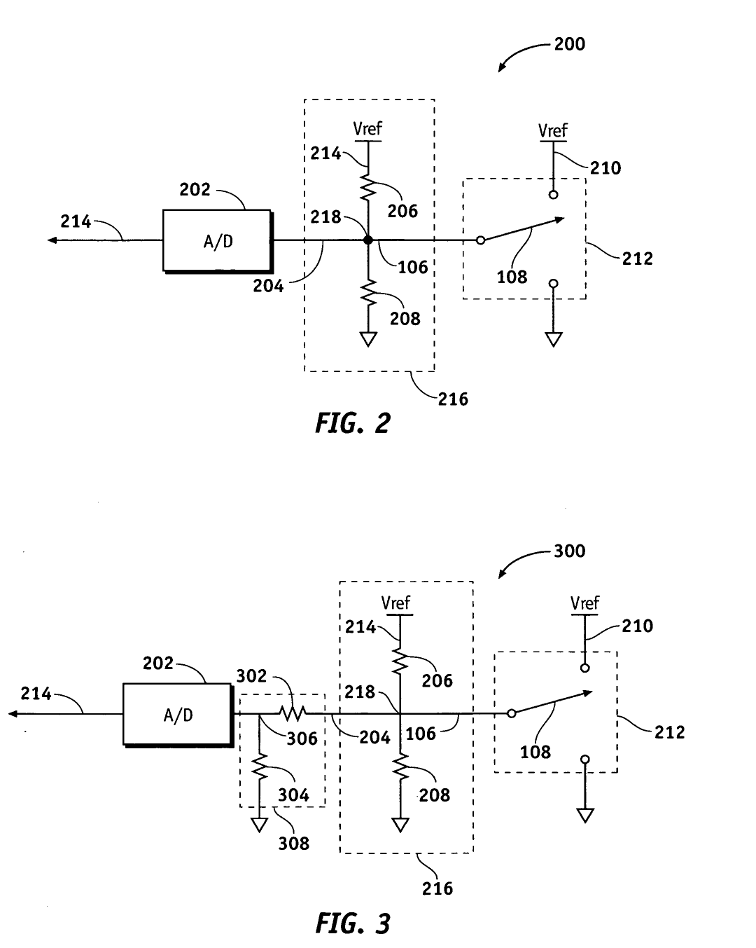

Ternary switching may be implemented within the context of a transmission control system in any manner. Referring now to FIG. 2, an exemplary ternary switching circuit 200 suitably includes switch contacts 212, a voltage divider circuit 216 and an analog-to-digital (A/D) converter 202. Switch contacts 212 suitably produce a three-state output signal that is appropriately transmitted across conductor 106 and decoded at voltage divider circuit 216 and/or A/D converter 202. The circuit 200 shown in FIG. 2 may be particularly useful for embodiments wherein a common reference voltage (V_{ref}) for A/D converter 202 is available to switch contacts 212 and voltage divider circuit 216, although circuit 200 may be suited to array of alternate environments as well.

Switch contacts 212 are any devices, circuits or components capable of producing a binary, ternary or other appropriate output on conductor 106. In various embodiments, switch contacts 212 are implemented with a conventional double-throw switch as may be commonly found in many vehicles. Alternatively, contacts 212 are implemented with a multi-position operator or other voltage selector as appropriate. Contacts 212 may be implemented with a conventional three-position low-current switch, for example, as are commonly found on many vehicles. Various of these switches optionally include a spring member (not shown) or other mechanism to bias an actuator 106 (FIG. 1) into a default position, although bias mechanisms are not found in all embodiments. Switch contacts 212 conceptually correspond to the various switches 102A-B shown in FIG. 1.

Switch contacts 212 generally provide an output signal selected from two reference voltages (such as a high reference voltage (e.g. Vref) and a low reference voltage (e.g. ground)), as well as an intermediate value. In an exemplary embodiment, Vref is the same reference voltage provided to digital circuitry in vehicle 100 (FIG. 1), and may be the same reference voltage provided to A/D converter 202. In various embodiments, Vref is on the order of five volts or so, although other embodiments may use widely varying reference voltages. The intermediate value provided by contacts 212 may correspond to an open circuit (e.g. connected to neither reference voltage), or may reflect any intermediate value between the upper and lower reference voltages. An intermediate open circuit may be desirable for many applications, since an open circuit will not typically draw a parasitic current on signal line 106 when the switch is in the intermediate state, as described more fully below. Additionally, the open circuit state is relatively easily implemented using conventional low-current three-position switch contacts 212.

Contacts 212 are therefore operable to provide a ternary signal 106 selected from the two reference signals (e.g. Vref and ground in the example of FIG. 2) and an intermediate state. This signal 106 is provided to decoder circuitry in one or more vehicle components (e.g. components 104, 110 in FIG. 1) as appropriate. In various embodiments, the three-state switch contact 212 is simply a multi-position device that merely selects between the two reference voltages (e.g. power and ground) and an open circuit position or other intermediate condition. The contact is not required to provide any voltage division, and consequently does not require electrical resistors, capacitors or other signal processing components other than simple selection apparatus. In various embodiments, switch 212 optionally includes a mechanical interlocking capability such that only one state (e.g. power, ground, intermediate) can be selected at any given time.

The signals 106 produced by contacts 212 are received at a voltage divider circuit 216 or the like at component 104, 110 (FIG. 1). As shown in FIG. 2, an exemplary voltage divider circuit 216 suitably includes a first resistor 206 and a second resistor 208 coupled to the same high and low reference signals provided to contacts 212, respectively. These resistors 206, 208 are joined at a common node 218, which also receives the ternary signal 106 from switch 212 as appropriate. In the exemplary embodiment shown in FIG. 2, resistor 206 is shown connected to the upper reference voltage Vref 214 while resistor 208 is connected to ground. Resistors 206 and 208 therefore function as pull-down and pull-up resistors, respectively, when signals 106 correspond to ground and Vref. While the values of resistors 206, 208 vary from embodiment to embodiment, the values may be selected to be approximately equal to each other such that the common node is pulled to a voltage of approximately half the Vref voltage when an open circuit is created by contact 212. Hence, three distinct voltage signals (i.e. ground, Vref/2, Vref) may be provided at common node 218, as appropriate. Alternatively, the magnitude of the intermediate voltage may be adjusted by selecting the respective values of resistors 206, 208 accordingly. In various embodiments, resistors 206, 208 are both selected as having a resistance on the order of about 1-50 kOhms, for example about 10 kOhms, although any other values could be used in a wide array of alternate embodiments. Relatively high resistance values may assist in conserving power and heat by reducing the amount of current flowing from Vref to ground, although alternate embodiments may use different values for resistors 206, 208.

Ternary voltages present at common node 218 are provided to an analog-to-digital converter 202 to decode and process the signals 204 as appropriate. In various embodiments, A/D converter 202 is associated with a processor, controller, decoder, remote input/output box or the like. Alternatively, A/D converter 202 may be a comparator circuit, pipelined A/D circuit or other conversion circuit capable of providing digital representations 214 of the analog signals 204 received. In an exemplary embodiment, A/D converter 202 recognizes the high and low reference voltages, and assumes intermediate values relate to the intermediate state. In embodiments wherein Vref is equal to about five volts, for example, A/D converter may recognize voltages below about one volt as a “low” voltage, voltages above about four volts as a “high” voltage, and voltages between one and four volts as intermediate voltages. The particular tolerances and values processed by A/D converter 202 may vary in other embodiments.

As described above, then, ternary signals 106 may be produced by contacts 212, transmitted across a single carrier, and decoded by A/D converter 202 in conjunction with voltage divider circuit 216. Intermediate signals that do not correspond to the traditional “high” or “low” outputs of contact 212 are scaled by voltage divider circuit 216 to produce a known intermediate voltage that can be sensed and processed by A/D converter 202 as appropriate. In this manner, conventional switch contacts 212 and electrical conduits may be used to transmit ternary signals in place of (or in addition to) binary signals, thereby increasing the amount of information that can be transported over a single conductor. This concept may be exploited across a wide range of automotive and other applications, including transmission control as described more fully below.

Referring now to FIG. 3, an alternate embodiment 300 of a switching circuit suitably includes an additional voltage divider 308 in addition to contact 212, divider circuit 216 and A/D converter 202 described above in conjunction with FIG. 2. The circuit shown in FIG. 3 may provide additional benefit when one or more reference voltages (e.g. Vref) provided to A/D converter 202 are unavailable or inconvenient to provide to contact 212. In this case, another convenient reference voltage (e.g. a vehicle battery voltage B+, a run/crank signal, or the like) may be provided to contact 212 and/or voltage divider circuit 216 as shown. Using the concepts described above, this arrangement provides three distinct voltages (e.g. ground, B+/2 and B+) at common node 204. These voltages may be out-of-scale with those expected by conventional A/D circuitry 202, however, as exemplary vehicle battery voltages may be on the order of twelve volts or so. Accordingly, the voltages present at common node 204 are scaled with a second voltage divider 308 to provide input signals 306 that are within the range of sensitivity for A/D converter 202.

In an exemplary embodiment, voltage divider 308 includes two or more resistors 302 and 304 electrically arranged between common node 218 and the input 306 to A/D converter 202. In FIG. 3, resistor 302 is shown between nodes 208 and 306, with resistor 304 shown between node 306 and ground. Various alternate divider circuits 308 could be formulated, however, using simple application of Ohm's law. Similarly, the values of resistors 302 and 304 may be designed to any value based upon the desired scaling of voltages between nodes 218 and 306, although designing the two resistors to be approximately equal in value may provide improved signal-to-noise ratio for circuit 300.

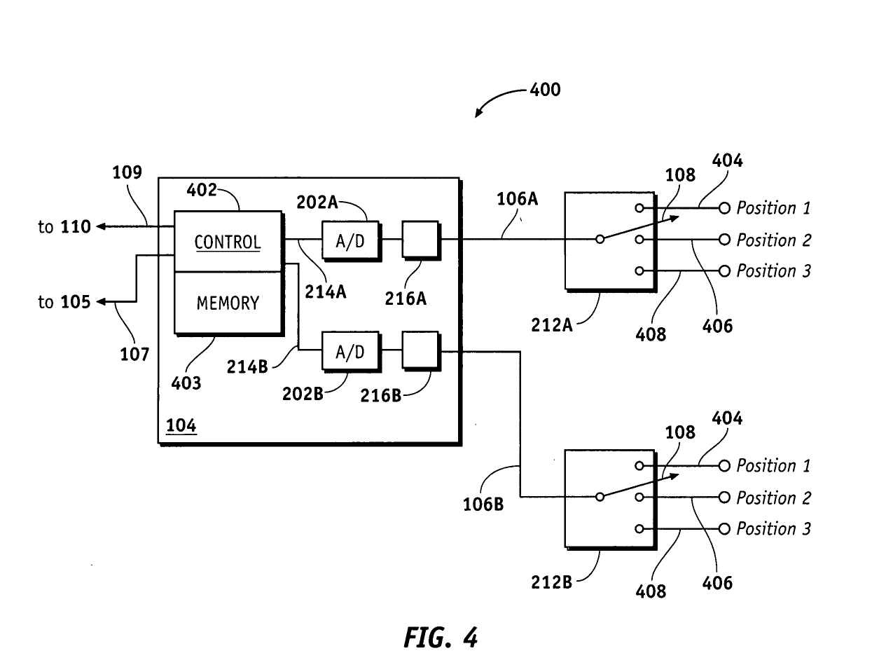

Using the concepts set forth above, a wide range of control circuits and control applications may be formulated, particularly within automotive and other vehicular settings. As mentioned above, the binary and/or ternary signals 106 produced by contacts 212 may be used to provide control data to any number of vehicle components, such as transmission control module 104 (FIG. 1). With reference now to FIG. 4, control module 104 suitably maps the various positions 404, 406, 408 of contacts 212A-B to corresponding operating states that can be represented by signals 107 and/or 109 provided to indicator 105 and/or controller 110 (FIG. 1), respectively. As described above, control module 104 suitably includes (or at least communicates with) one or more processors or other processors 402 that include and/or communicate with A/D converter 202 and voltage divider circuit 210 to receive ternary signals 106A-B from contacts 212. The digital signals 214 produced by A/D converter 202 are processed by controller 402 as appropriate to respond to the three-state input received at contacts 212. Accordingly, mapping between states 404, 406 and 408 is typically processed by controller 402, although alternate embodiments may include signal processing in additional or alternate portions of system 400. Signals 214 received from contacts 212 may be processed in any appropriate manner, and in a further embodiment may be stored in digital memory 403 (or another location) as appropriate. Although shown as separate components in FIG. 4, memory 403 and processor 402 may be logically and/or physically integrated in any manner. Alternatively, memory 403 and processor 402 may simply communicate via a bus or other communications link as appropriate.

Although FIG. 4 shows an exemplary embodiment wherein controller 402 communicates with two switch contacts 212A-B, alternate embodiments may use any number or arrangement of switch contacts 212, as described more fully below. The various outputs 214A-B of the switching circuitry may be combined or otherwise processed by controller 402, by separate processing logic, or in any other manner, to arrive at suitable commands provided to transmission 110. The commands resulting from this processing may be used to place transmission 110 into a desired state, for example, or to otherwise adjust the performance or status of the device. In various embodiments, a desired state of transmission 110 is determined by processing the various input signals 214A-B received from contacts 212A-B (respectively). This processing may be executed in any manner, including performing a logical AND operation on the various signals 214A-B, checking the values of signals 214A-B against a lookup table or other data structure maintained in memory 403 (or elsewhere), or according to any other technique. Using the various signaling and processing techniques described herein, the desired state of transmission 110 can be determined from the collective values of the various input signals 214A-B.

As used herein, input state 404 is arbitrarily referred to as ‘1’ or ‘high’ and corresponds to a short circuit to Vref, B+ or another high reference voltage. Similarly, input state 408 is arbitrarily referred to as ‘0’ or ‘low’, and corresponds to a short circuit to ground or another appropriate low reference voltage. Intermediate input state 406 is arbitrarily described as ‘value’ or ‘v’, and may correspond to an open circuit or other intermediate condition of switch 212. Although these designations are applied herein for consistency and ease of understanding, the ternary states may be equivalently described using other identifiers such as “0”, “1” and “2”, “A”, “B” and “C”, or in any other convenient manner. The naming and signal conventions used herein may therefore be modified in any manner across a wide array of equivalent embodiments.

Ternary switches (optionally in combination with binary or other switches) may be used to improve the robustness of various control systems, including those used in transmission control. Various techniques for improving robustness and safety are described in conjunction with the embodiments shown below. In general, however, intermediate state 406 of contacts 212 may be used to represent a “power off”, “default” or “no change” state, since the open circuit causes little or no current to flow from contacts 212, thereby conserving electrical power. Similarly, because ‘open circuit’ faults are typically more likely to occur in practice than faulty shorts to either reference voltage, the more-likely fault (e.g. open circuit) conditions may be used to represent the least disruptive states of device 110 to preserve robustness. Stated another way, open circuits may be diagnosed by identifying unexpected intermediate (e.g. “v”) values present on one or more signal inputs. Again, the various states of contacts 212 described herein may be re-assigned in any manner to represent the various inputs and/or operating states of components 104 and 110 as appropriate.

Using the concepts of ternary switching, various exemplary mappings of contacts 212 for vehicle transmission and other applications may be defined as set forth below. In vehicle transmissions, two or more switch contacts 212 are generally arranged proximate to an actuator 108, with the outputs of the switches corresponding to the various states/positions of actuator 108. Each position of actuator 108, in turn, represents a desired operating mode of transmission 110. In such embodiments, one or more controllers 402 may be used to decode the various states of multiple independent switch contacts 212A-B to identify the location of actuator 108, which in turn identifies a desired operating state of transmission 110. While FIG. 4 shows two signal contacts 212A-B providing two ternary signals 106A-B to a common controller 402, however, it is not necessary that all embodiments be configured in such a manner. To the contrary, input signals 106 may be provided to any number of separate controllers 402 and/or control modules 104 that are located in any part of vehicle 100 (FIG. 1). Further, any number of binary, ternary and/or other types of switch contacts 212 may be interconnected or otherwise inter-mixed to create switching arrangements of any type. The concepts described above and below may therefore be readily implemented and expanded to create a wide array of state selection/indication systems suitable for vehicle transmissions, and may also have application in other settings.

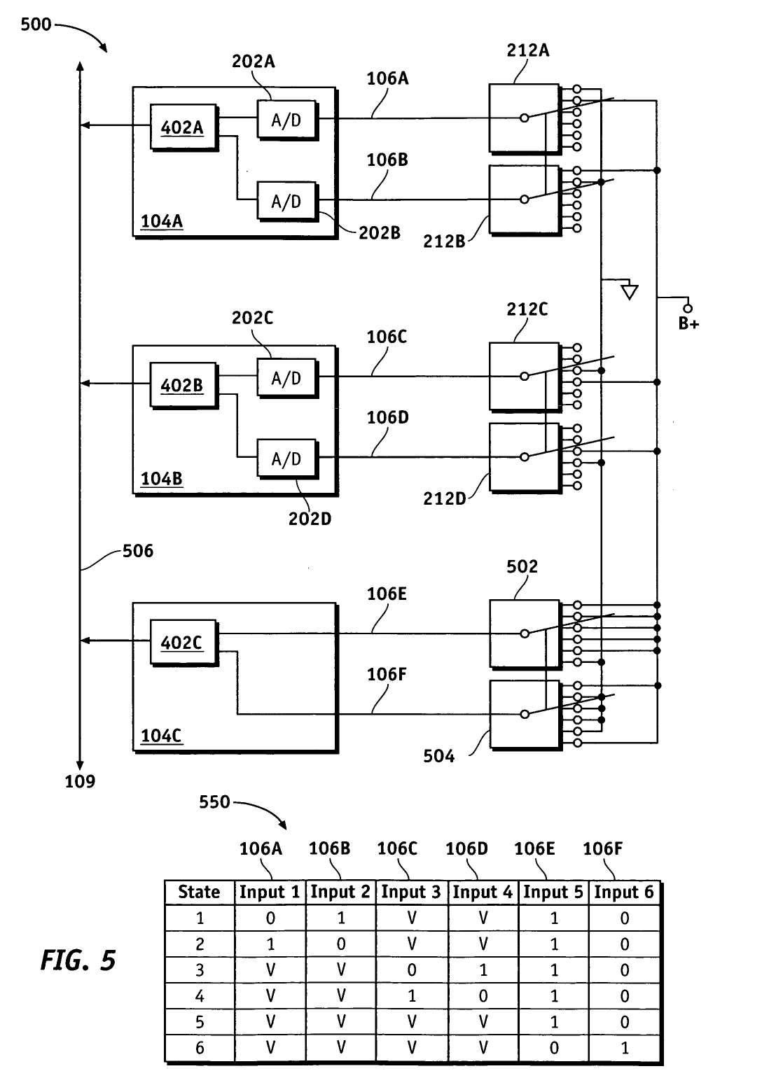

Referring now to FIG. 5, an exemplary architecture for implementing a robust transmission control system 500 suitably allows any number of control modules 104A-C to interact with any number of ternary switch contacts 212A-D and/or discrete switch contacts 502-504. Each control module 104A-C is able to communicate with the other modules 104 and/or with other external computing circuitry to share input signal values and/or other data. In the exemplary embodiment shown in FIG. 5, modules 104A-C suitably communicate via a bus 506, although the modules may alternatively communicate via any wired, wireless, optical or other signal transmission media. As a result of the modular structure of system 500, the various signal inputs 106A-F can be provided to any processing module 104A-C that has available input space. If a particular ETRS module lacks sufficient input space, for example, additional inputs on an ECM or other component could be used to receive transmission switching data, and signal values may be exchanged between components using bus 506 or another medium as appropriate. Consequently, there is no requirement that all input signals 106A-F be provided to a common control module 104.

The exemplary control system 500 shown in FIG. 5 includes four ternary switch contacts 212A-D and two discrete switch contacts 502, 504 to robustly represent six operating states of transmission 110. Contacts 212A-B in this embodiment provide ternary input signals 106A-B to control module 104A, contacts 212C-D provide ternary input signals 106C-D to control module 104B, and discrete contacts 502 and 504 provide discrete input signals 106E and 106F to control module 104C as shown. As discussed above, the various input signals 106A-F could be routed or otherwise provided to any number of control modules 104 in any combination. Further, some or all of input signals 106A-F could be provided to multiple control modules 104 in an alternate but equivalent embodiment. FIG. 5 also shows mechanical interlocking between contacts 212A and 212B, as well as between contacts 212C and 212D and between contacts 502 and 504. Contacts 212A and 212B, for example, may be interlocked such that when one contact is in the ‘high’ (e.g. B+) state, the other is in the ‘low’ (e.g. ground) state, and such that each of the contacts 212A-B are simultaneously in the intermediate (v) state. Similar limitations can be placed on the other contacts 212C-D, 502 and 504. By mechanically interlocking the various switch contacts with respect to each other, the relative states of the contact sets can be fixed, thereby further improving safety and robustness.

The various signal values used to represent the positions of actuator 108 (which in turn correspond to the operating states of transmission 110) can be assigned and processed in any manner. In various embodiments, signal values are assigned to maximize robustness. In conventional embodiments wherein open circuit faults can be assumed to be more likely than either “short to ground” faults or “short to battery voltage” faults, for example, signal values can be assigned to allow the most likely faults (in this case, open circuit faults) to be readily diagnosed. An unexpected occurrence of an open circuit (corresponding to an observed ‘intermediate’ value on any signal line 106) can therefore readily indicate the occurrence of a fault. An exemplary scheme for mapping input values of signals 106A-F to various operating states of transmission 110 is shown in inset table 550 of FIG. 5, although any other mapping scheme could be used in a wide array of alternate embodiments. In the scheme shown in table 550, operating modes are identified by opposing reference values on the two signals 106 received at any control module 104, and by intermediate values on the remaining ternary signals 106. Because the intermediate value can be produced with an open circuit condition, using the intermediate value to represent default or most frequently occurring states can lessen the amount of current consumed by system 500.

The various states 1-6 shown in table 550 may be mapped to operating modes (e.g. “park”, “reverse”, “neutral”, “drive”, “2^{nd} gear”, “low” and the like) in any manner. That is, any state could be assigned to represent any operating mode of transmission 110. Using the scheme shown in table 550, determinations of various states can be readily separated or interconnected between various modules 104 as appropriate. Some or all of the six input signals 106A-F may be processed with a logical AND operation and/or referenced in a lookup table to ascertain the current position of actuator 108, and therefore the desired state of transmission 110. In various embodiments, at least modules 104A and 104B exchange signal information on any periodic or other basis. In such embodiments, information is exchanged between modules 104 at time intervals that are greater than any applicable bounce times of signal contacts 212, but less than any applicable human factors, security or other time constraints (which may be on the order of 50 milliseconds or so). In one exemplary embodiment, signal information is exchanged on the order of every 2 milliseconds or so, although other embodiments may have widely varying exchange times.

The exemplary signal representation scheme shown in table 550 is highly robust, meaning that signal faults are extremely unlikely and/or are readily detected. In various embodiments, States 1-4 of table 550 generally correspond to the primary operating modes of transmission 110 (e.g. “park”, “reverse”, “neutral” and “drive”). By mapping States 5 and 6 (which are determined primarily by signals 106E and 106F) in table 550 to infrequently used or less critical transmission modes (e.g. 2ndGear or Low), for example, signals 106E-F can be ignored in the event of a fault condition on one or more inputs 106A-D. The signaling arrangement shown in table 550 provides additional robustness in that at least two signals 106A-F change value to produce any state transition at transmission 110. As a result, if any input signal 106A-F should become unavailable due to a fault or other condition, the desired state of transmission 110 can still be determined from the remaining signal values. Moreover, the unavailable signal can be readily identified through the unexpected occurrence of an open circuit or intermediate value condition. Signal values 106A-F may also be stored in memory (e.g. memory 403 in FIG. 4) and compared against subsequent signal values to further enhance system robustness.

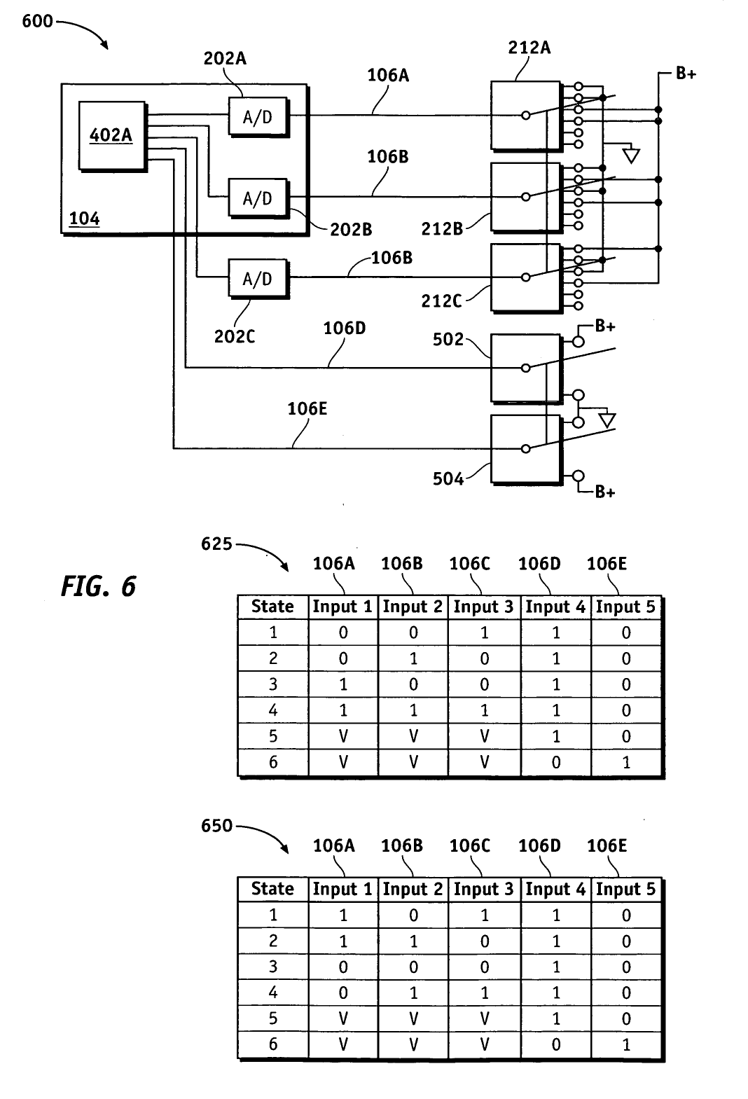

With reference now to FIG. 6, an alternate embodiment of a transmission control system 600 suitably includes three ternary input signals 106A-C and two discrete/binary input signals 106D-E to represent six robust operating states. Although the exemplary system 600 shown in FIG. 6 includes a single control module 104, alternate embodiments could separate processing of one or more signals 106A-E into a one or more additional control modules as discussed above. Discrete input signals 106D-E, for example, could be processed separately from ternary input signals 106A-C in an alternate embodiment. In still other embodiments, discrete switch contacts 502 and 504 and discrete signals 106D-E could be eliminated entirely or replaced with one or more ternary structures, as described more fully below.

Two robust signal mapping schemes are shown in inset tables 625 and 650 of FIG. 6, with any state in either table corresponding to any operating mode of transmission 110. In various embodiments, states 1-4 in tables 325 and 350 correspond to the primary operating modes of transmission 110 (e.g. “park”, “reverse”, “neutral” and “drive”) and states 5-6 correspond to the less-frequent operating modes (e.g. D2, D3, “2^{nd} gear”, “low gear” or the like). In such embodiments, the lesser-used modes are selected by discrete inputs 106D-E to further improve the robustness of system 600. If any single occurrence of an open circuit condition (e.g. an intermediate “value” or “v”) on any input signal 106A-C were to occur in such embodiments, the discrete inputs 106D-E can be temporarily ignored (along with the faulty input signal), yet the operating state can still be selected from States 1-4 using the remaining two ternary input signals. If Input2 were to fail, for example, the remaining values of Input1 and Input 3 can still be used to select or indicate States 1-4.

Like the embodiment presented in FIG. 5 above, any transition from one state to another in either table 325 or 350 requires at least two signal transitions for improved robustness. A transition from State 1 to State 2 in table 325, for example, could only occur in response to signal 106B (“Input2”) transitioning from a low value (“0”) to a high value (“1”) while signal 106C (“Input3”) transitions from a high value (“1”) to a low value (“0”). Similarly, a transition from State 2 to State 4 could only result from signals 106A and 106C (“Input1” and “Input3”, respectively) simultaneously transitioning from allow value (“0”) to a high value (“1”). If only one signal transition were to occur, the resulting combination of signal values would not match any state of table 325, thereby indicating a fault. Moreover, the source of the fault could be readily identified by comparing current signal values to past values stored in memory (e.g. memory 403 in FIG. 4). Similar results could be obtained using the signal map shown in table 650. Indeed, the state values shown in tables 325 and 350 are complementary to each other, with each state table representing fault conditions for the other table. That is, any occurrence of any state in table 350 would readily indicate a fault condition according to the state mappings of table 325, and vice versa. Note that, while the logic diagram of system 600 shows switch contacts 212A-212C wired in accordance with the table 325 scheme, the table 350 scheme could be readily implemented by simply swapping the battery and ground connections applied to switch contact 212A. Again, any signal mapping or wiring scheme could be used in a wide array of alternate embodiments.

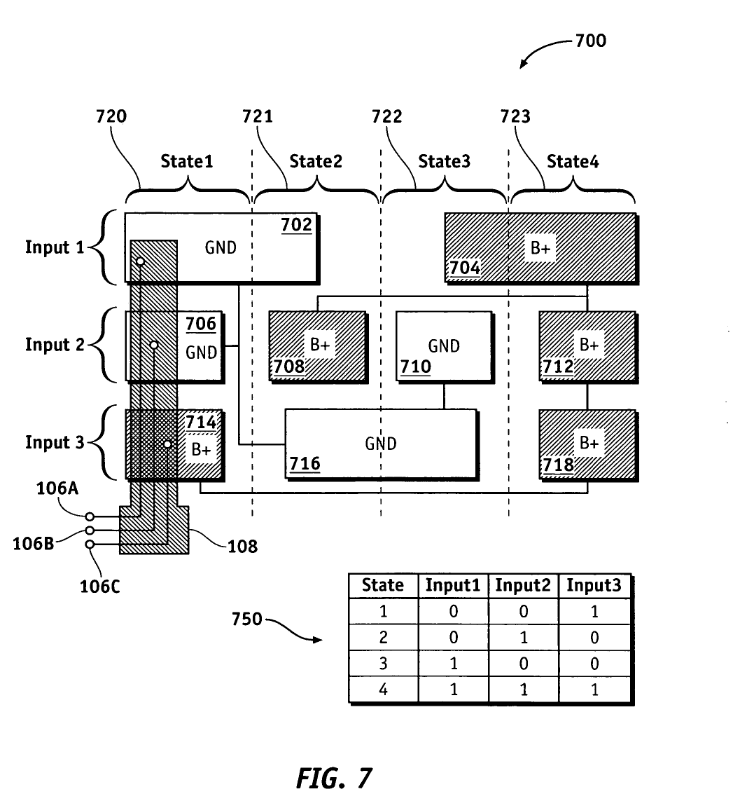

Through proper arrangement of the electrical contacts with respect to actuator 108, unique combinations of signals 106A-F can be created for each position of actuator 108. Referring now to FIG. 7, an exemplary switching system 700 suitable for representing the four primary operating states of transmission 110 (FIG. 1) with three ternary signals 106A-C suitably includes any number of electrodes, electrical contacts or other conducting members 702, 704, 708, 710, 712, 714, 716 and 718 arranged to create four unique positions 720-723 for actuator 108. Some or all of the positions 720-723 correspond to operating modes of the transmission as appropriate. Layout 700 shown in FIG. 7, for example, could be used to implement States 1-4 shown in inset table 750 (which corresponds to states 1-4 of table 625 of FIG. 6). Table 750 shows an example of a robust signaling scheme that allows the state of transmission 110 to be determined even if any input signal 106A-C were to become unavailable. This is because any transition between the states shown in table 750 would require two signal value transitions (e.g. low to high or high to low). Although not shown in FIG. 7, additional states (e.g. states 5-6 in table 625) could be provided by additional electrodes. As actuator 108 moves through the various operating positions 720-723, actuator 108 electrically interacts with the various contacts 702-718 to produce electrical signals 106A-C that indicate the position 720-723 of actuator 108, which in turn generally corresponds to a desired operating state of transmission 110. As shown in FIG. 7, electrodes 702 and 704 suitably cooperate with actuator 108 to provide a first input signal (Input1) 106A, electrodes 706, 708, 710 and 712 cooperate with actuator 108 to provide a second input signal (Input2) 106B, and electrodes 714, 716 and 718 cooperate with actuator 108 to provide a third input signal (Input3) 106C as appropriate. The various electrical contacts are suitably coupled to appropriate reference voltages (e.g. ground, battery voltage B+, or the like). As actuator 108 comes into contact with the various electrodes, the voltages applied to the various electrodes are provided as electrical signals 106A-C. If any signal 106A-C is not in contact with an electrode having a pre-defined voltage (e.g. ground, B+ or the like), an open circuit condition is created for that signal. This condition would only occur in the exemplary embodiment shown in FIG. 7 in the event of a broken electrical connection or other fault, although alternate embodiments may deliberately create open circuit conditions to exploit the “intermediate value” ternary state described above.

Signals 106A-C can be relayed to an A/D converter 202 and properly decoded at a controller 402 as appropriate. Decoding may be accomplished through any discrete or integrated processing circuitry, through digital processing (e.g. using a lookup table or other data structures), or through any other technique. As a result, the collective values of signals 106A-C can be decoded at one or more control modules 104 to determine the position 720-723 of actuator 108 with respect to the various electrodes 702-718, which in turn indicates a desired operating state of transmission 110 selected by the vehicle operator. This decoding may be performed using conventional logical operations (e.g. a logical AND of the various signal values received), a lookup table, and/or any other techniques as appropriate. Once again, the particular layout and mapping scheme shown in FIGS. 6 and 7 is exemplary, and could be modified and/or supplemented significantly in other embodiments.

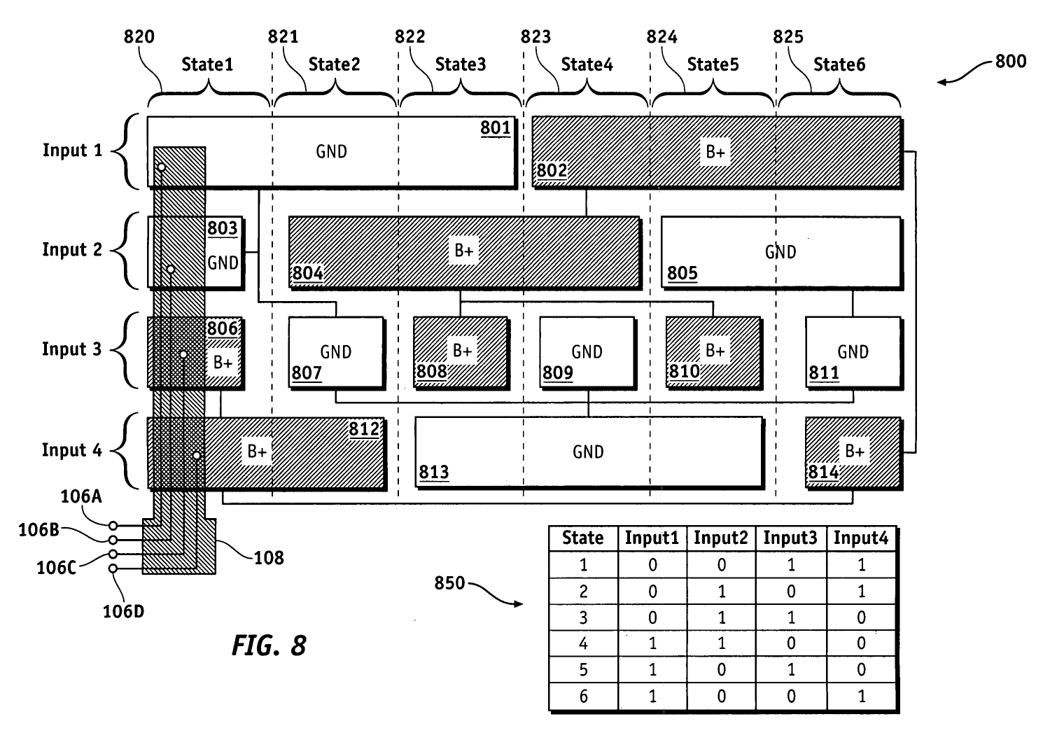

Turning now to FIG. 8, an exemplary layout 800 suitable for representing six transmission states with four ternary signals 106A-D can be formulated using various electrodes 801-814. As actuator 108 (FIG. 1) is moved between various locations 820-825 (corresponding to States 1-6), the various electrodes 801-814 suitably interact with electrical contacts on the actuator produce appropriate signals 106A-D that can be provided to one or more control modules 104 as appropriate. In the embodiment shown in FIG. 8, electrodes 801 and 802 interact with actuator 108 (FIG. 1) to produce ternary input signal 106A, electrodes 803, 804 and 805 interact with actuator 108 to produce ternary input signal 106B, electrodes 806, 807, 808, 809, 810 and 811 interact with actuator 108 to produce ternary input signal 106C, and electrodes 812, 813 and 814 interact with actuator 108 to produce ternary input signal 106D. Table 850 shows a corresponding mapping of signal values to the various operating states of transmission 110. Like the embodiments described above, table 850 uses high and low ternary values (e.g. “0” and “1”, which may correspond to ground and battery voltages, respectively, in various embodiments) exclusively to represent the various operating states. As a result, any occurrence of the third “intermediate” ternary value can readily indicate a fault condition. Further, the various signal values may be selected in manner that encourages robustness (e.g. the scheme shown in Table 850) by requiring multiple signal transitions to produce any change in operating state 820-825. In such embodiments, operating state 820-825 can be deduced from remaining signal inputs 106A-D even if one of the input signals or either reference voltage were to become corrupt or unavailable. Even more robustness can be provided by comparing current signal values to prior signal values stored in memory. By comparing the current signal values with those obtained in a previous state, any undesired shorts to high or low reference voltages (as well as any open circuits) can be readily identified and isolated. Again, the robust signal mapping shown in Table 850 contains sufficient data redundancy that allows the operating state to be determined even if one of the input signals were to fail. Other mapping tables, techniques and schemes may provide equivalent functionality. Moreover, additional discrete and/or ternary signaling inputs could be additionally provided, thereby allowing system 800 to represent any number of operating states of transmission 110. By adding a pair of discrete switch contacts 502, 504 using the concepts described in conjunction with FIG. 5, for example, system 800 could robustly represent as many as eight transmission operating modes with only six signal inputs 106. Such systems 800 may be particularly useful in providing electronic control to a four-speed or five-speed transmission, or for any other purpose.

Using the concepts, systems, structures and techniques set forth herein, many different types of electronic controls could be formulated for placing a vehicle transmission into a desired state in response to a position of an actuator selected by a vehicle operator. The general concepts described herein could be modified in many different ways to implement a diverse array of equivalent multi-state controls for transmissions and other devices. For example, the various positions of actuator 108 may be extracted and decoded through any type of processing logic, including any combination of discrete components, integrated circuitry and/or software. Moreover, the various positional and switching structures shown in the figures and tables contained herein may be modified and/or supplemented in any manner. That is, the various input signals could be arranged in any order and in any combination in a wide array of alternate embodiments.

Still further, the concepts presented herein may be applied to any number of ternary and/or discrete switches, or any combination of ternary and discrete switches to create any number of potential or actual robust and non-robust state representations. Similar concepts to those described above could be applied to systems incorporating additional ternary and/or discrete input signals, for example, allowing for control systems capable of processing any number of states in a wide array of equivalent embodiments. Alternatively or additionally, some or all of the inputs used in defining the various states could be used for further redundancy purposes, thereby further improving the reliability and robustness of the switching systems implemented.

Although the various embodiments are most frequently described with respect to automotive applications, and electronically-controlled automatic transmissions in particular, the invention is not so limited. Indeed, the concepts, circuits and structures described herein could be readily applied in any commercial, home, industrial, consumer electronics or other setting. The concepts and structures described herein could similarly be readily applied in aeronautical, aerospace, defense, marine or other vehicular settings, for example, as well as in the automotive context.

While at least one exemplary embodiment has been presented in the foregoing detailed description, a vast number of variations exist. The various circuits described herein may be modified through conventional electrical and electronic principles, for example, or may be logically altered in any number of equivalent embodiments without departing from the concepts described herein. Further, the various signals, inputs, states and the like could be arranged or grouped in any manner across a wide range of equivalent embodiments. The exemplary embodiments described herein are intended only as examples, and are not intended to limit the scope, applicability, or configuration of the invention in any way. Rather, the foregoing detailed description will provide those skilled in the art with a convenient road map for implementing one or more exemplary embodiments. Various changes can therefore be made in the functions and arrangements of elements set forth herein without departing from the scope of the invention as set forth in the appended claims and the legal equivalents thereof.

What is claimed is:

1. A robust control system for placing a transmission into a desired one of a plurality of operating states in response to a position of a multi-position actuator, the control system comprising:
a first switch contact coupled to the multi-position actuator and configured to provide a first ternary input value as a function of the position of the multi-position actuator;
a second switch contact coupled to the multi-position actuator and configured to provide a second ternary input value as a function of the position of the multi-position actuator; and
control logic configured to receive the first and second ternary input values and to determine the desired operating state of the transmission based at least in part upon the first and second ternary input values received, wherein each of the plurality of operating states are represented by a unique combination of the first and second ternary input values selected such that a transition from a first one of the plurality of operating states to a second of the plurality of operating states results from a transition in both the first and second ternary input values.

2. The control system of claim 1 wherein the first and second ternary input values are each selected from a high value, a low value and an intermediate value.

3. The control system of claim 2 wherein one of the plurality of operating states is represented by the first ternary input value having the high value and the second ternary input signal having the low value.

4. The control system of claim 3 wherein a second one of the plurality of operating states is represented by the first ternary input value having the low value and the second ternary input signal having the high value.

5. The control system of claim 4 wherein a third one of the plurality of operating states is represented by the first and second ternary input values each having the intermediate value.

6. The control system of claim 5 wherein the third one of the plurality of operating states corresponds to a default operating state.

7. The control system of claim 2 wherein the intermediate value corresponds to an open circuit condition.

8. The control system of claim 1 wherein the plurality of operating states comprises first and second operating states each determined by the first and second ternary input values having opposite values.

9. The control system of claim 8 wherein the plurality of operating states comprises a third operating state determined by the first and second ternary input values each having an intermediate value.

10. The control system of claim 1 further comprising a third switch contact coupled to the multi-position actuator and configured to provide a third ternary input value as a function of the position of the multi-position actuator, and wherein the control logic is further configured to receive the third ternary input value and to determine the desired operating state of the transmission based at least in part upon the first, second and third ternary input values received.

11. The control system of claim 10 further comprising a fourth switch contact coupled to the multi-position actuator and configured to provide a fourth ternary input value as a function of the position of the multi-position actuator, and wherein the control logic is further configured to receive the fourth ternary input value and to determine the desired operating state of the transmission based at least in part upon the first, second, third and fourth ternary input values received.

12. The control system of claim 11 wherein the control logic comprises a first processing module and a second processing module in communication with each other, and wherein the first processing module is configured to receive the first and second ternary input values and wherein the second processing module is configured to receive the third and fourth processing modules.

13. The control system of claim 10 further comprising a first and a second discrete switch contact each coupled to the multi-position actuator and configured to generate a first and a second discrete input value, respectively, as a function of the position of the multi-position actuator, and wherein the control logic is further configured to receive the first and second discrete ternary input value and to determine the desired operating state of the transmission based at least in part upon the first, second and third ternary input values and upon the first and second discrete input values received.

14. The control system of claim 13 wherein the first and second discrete inputs are configured to exhibit a first state corresponding to a first gear selection and a second state corresponding to a second gear selection of the transmission.

15. A robust control system for placing a transmission into a desired one of a plurality of operating states in response to a position of a multi-position actuator, the control system comprising:
a plurality of three-state switch contacts in communication with the multi-position actuator and configured to provide one of a plurality of ternary input values as a function of the position of the multi-position actuator; and
control logic configured to receive each of the plurality of ternary input values and to determine the desired operating state of the transmission based at least in part upon the ternary input values received, wherein each of the plurality of operating states are represented by a unique combination of the ternary input values selected such that any transition from one of the plurality of operating states to another of the plurality of operating states results from a signal transition in at least two of the ternary input values.

16. The control system of claim 15 wherein the control logic further comprises a plurality of analog-to-digital converters, each configured to decode one of the ternary input values from one of the plurality of three-state switch contacts.

17. The control system of claim 15 wherein the control logic comprises a first processing module and a second processing module in communication with each other, and wherein the first processing module is configured to receive at least a first pair of the plurality of ternary input values and wherein the second processing module is configured to receive at least a second pair of the plurality of ternary input values.

18. The control system of claim 15 wherein each of the ternary input values are selected from a high value (1), a low value (0) and an intermediate value (v).

19. The control system of claim 18 wherein the plurality of three-state switch contacts comprises a first ternary switch contact (Input1), a second ternary switch contact (Input2) and a third ternary switch contact (Input3).

20. The control system of claim 19 wherein the plurality of three state switch contacts are configured as follows:

| State | Input1 | Input2 | Input3 |
|---|---|---|---|
| 1 | 0 | 0 | 1 |
| 2 | 0 | 1 | 0 |
| 3 | 1 | 0 | 0 |
| 4 | 1 | 1 | 1 |

21. The control system of claim 19 wherein the plurality of three state switch contacts are configured as follows:

| State | Input1 | Input2 | Input3 |
|---|---|---|---|
| 1 | 1 | 0 | 1 |
| 2 | 1 | 1 | 0 |
| 3 | 0 | 0 | 0 |
| 4 | 0 | 1 | 1 |

22. The control system of claim 19 further comprising a first and a second discrete switch contact configured to provide a first and a second discrete input value, respectively, to the control logic, and wherein the control logic is further configured to determine the desired operating state of the transmission based at least in part upon the first and second discrete input values.

23. The control system of claim 19 wherein the plurality of three-state switch contacts comprises a first ternary switch contact configured to produce a first ternary value (Input1), a second ternary switch contact configured to produce a second ternary value (Input2), a third ternary switch contact configured to produce a third ternary value (Input3) and a fourth ternary switch contact configured to produce a fourth ternary value (Input4).

24. The control system of claim 23 wherein the plurality of three state switch contacts are configured as follows:

| State | Input1 | Input2 | Input3 | Input4 |
|---|---|---|---|---|
| 1 | 0 | 0 | 1 | 1 |
| 2 | 0 | 1 | 0 | 1 |
| 3 | 0 | 1 | 1 | 0 |
| 4 | 1 | 1 | 0 | 0 |
| 5 | 1 | 0 | 1 | 0 |
| 6 | 1 | 0 | 0 | 1 |

25. The control system of claim 23 wherein the plurality of three state switch contacts are configured as follows:

| State | Input1 | Input2 | Input3 | Input4 |
|---|---|---|---|---|
| 1 | 0 | 1 | v | v |
| 2 | 1 | 0 | v | v |
| 3 | v | v | 0 | 1 |
| 4 | v | v | 1 | 0 |

26. The control system of claim 25 wherein the control logic comprises a first processing module and a second processing module in communication with each other, and wherein the first processing module is configured to receive the first and second ternary input values and wherein the second processing module is configured to receive the third and fourth ternary input values.

27. The control system of claim 25 further comprising a first discrete switch contact configured to provide a first discrete input value (Input5) to the control logic and a second discrete switch contact configured to provide a second discrete input value (Input6) to the control logic, and wherein the control logic is further configured to determine the desired operating state of the transmission based at least in part upon the first and second discrete input values.

28. The control system of claim 27 wherein the plurality of three state switch contacts and the discrete switch contact are configured as follows:

| State | Input1 | Input2 | Input3 | Input4 | Input5 | Input6 |
|---|---|---|---|---|---|---|
| 1 | 0 | 1 | v | v | 1 | 0 |
| 2 | 0 | 1 | v | v | 1 | 0 |
| 3 | v | v | 0 | 1 | 1 | 0 |
| 4 | v | v | 0 | 1 | 1 | 0 |
| 5 | v | v | v | v | 1 | 0 |
| 6 | v | v | v | v | 0 | 1 |

29. The control system of claim 28 wherein the control logic comprises a first processing module and a second processing module in communication with each other, and wherein the first processing module is configured to receive at least some of the ternary input values and wherein the second processing module is configured to receive the first and second discrete input values.

30. A method for identifying a desired one of a plurality of operating states of a vehicle transmission in response to a position of a multi-position actuator, the method comprising the steps of:
generating a plurality of three-state ternary input signals as a function of the position of the multi-position actuator at a plurality of ternary switch contacts;
receiving each of the plurality of ternary input values at a control module; and
determining the desired operating state of the transmission based at least in part upon the ternary input values received, wherein each of the plurality of operating states are represented by a unique combination of the ternary input values such that any transition from one of the plurality of operating states to another of the plurality of operating states results from a signal transition in at least two of the ternary input values.

31. The method of claim 30 further comprising the step of providing an indicator signal to an indicator module in response to the determining step to thereby indicate the operating state of the transmission to a vehicle operator.

32. The method of claim 30 further comprising the step of providing a transmission control signal to the transmission in response to the determining step to thereby place the transmission into the desired operating state.

33. The method of claim 30 further comprising the step of evaluating the ternary input values received to identify a fault condition.

34. The method of claim 33 wherein the evaluating step comprises comparing present ternary input values to prior ternary input values.

35. The method of claim 33 wherein the evaluating step comprises comparing the ternary input values to a table of known states to identify any deviations there from.

36. The method of claim 35 wherein the table is a lookup table stored in a digital memory.

37. The method of claim 30 wherein the determining step comprises performing a logical AND operation upon the plurality of ternary input values.

38. A system for selecting a desired one of a plurality of operating states of a vehicle transmission in response to a position of a multi-position actuator, the system comprising:
means for generating a plurality of three-state ternary input signals as a function of the position of the multi-position actuator at a plurality of ternary switch contacts;
means for receiving each of the plurality of ternary input values at a control module; and
means for determining the desired operating state of the transmission based at least in part upon the ternary input values received, wherein each of the plurality of operating states are represented by a unique combination of the ternary input values such that any transition from one of the plurality of operating states to another of the plurality of operating states results from a signal transition in at least two of the ternary input values.

39. The system of claim 38 wherein the means for receiving comprises an analog-to-digital converter.
